(19) United States
(12) Patent Application Publication
(10) Pub. No.: US 2005/0265681 A1
(43) Pub. Date: Dec. 1, 2005

(54) Optical fiber product and process of making

(76) Inventor: Zhiping Xie, Dongguan City (CN)

Correspondence Address: THORPE NORTH & WESTERN, LLP., 8180 SOUTH 700 EAST, SUITE 200, P.O. BOX 1219, SANDY, UT, 84070, US

(21) Appl. No.: 10/964,951

(22) Filed: Oct. 13, 2004

(30) Foreign Application Priority Data
May 27, 2004 (CN) CN200410044347.2

(51) Int. Cl. G02B 6/00

(52) U.S. Cl. 385/137; 385/147

(57) ABSTRACT

A polyurethane optical fiber product includes a casing made of polyurethane material and an optical fiber positioned in the casing. By using polyurethane material, this invention greatly simplifies the manufacturing process and increases the production efficiency. In addition, since the material is elastic in nature, the semi-finished products and finished products are not easily broken or cracked from an impact or fall which may occur during transportation. The elastic nature of the material also makes it unnecessary to use special packing materials to meet safety and protection requirements.

This patent application claims priority from Chinese Patent Application Serial No. 200410044347.2 filed on May 27, 2004.

### BACKGROUND

The present invention relates generally to optical fiber products.

Most current optical fiber products use a polymer resin, such as polyethylene, for the optical fiber casing. The following is a conventional process for manufacture of an optical fiber product. First, a forming die of a predetermined shape with a depression made of silicon and a forming die casing made of white plaster is prepared. This forming die is easily distorted during the preparation process, thus the cost of manufacture is relatively high. Second, to make the optical fiber casing, a prepared polymer resin liquid, such as polyethylene, is poured into the forming die, and the forming die is manually rotated to evenly mix the polymer resin liquid and a solidifying agent, and to allow the mixture to flow evenly in the forming die until it solidifies to form an optical fiber casing. This process requires a lot of manual labor and hence the productivity is rather low. In addition, a large working space is needed.

The semi-finished optical fiber casing needs to be finished to produce a color-painted optical fiber casing. To install optical fibers into the optical fiber casing, holes must be drilled in the fiber casing at certain locations (e.g using an electric drill) so that optical fibers can then be installed using a guiding tube, a guiding plate, a hook, and other tools. This process is complicated and inefficient.

With respect to packaging, since the optical fiber casing made of polymer resin is hollow and very fragile, it cannot pass a drop test if it is packed with conventional packing materials. Therefore, a special packing material with greater strength, such as styrofoam, needs to be used to make the inner packing case. This material not only leads to increased cost, but may also have adverse environmental impact.

### SUMMARY

The present invention provides a polyurethane optical fiber product that is robust and easy to manufacture. The present invention also provides an easy and highly efficient polyurethane optical fiber product manufacturing technique.

The polyurethane optical fiber product of the present invention comprises an optical fiber casing and optical fibers which are attached to the casing at predetermined positions, and a feature is that the optical fiber casing is made of a polyurethane material. The optical fiber casing consists of two parts, a front part and a back part, which are bound together as a whole using an adhesive.

The polyurethane optical fiber product manufacturing process comprises the steps of: 1) preparing a mold having a front half die and a back half die of a predetermined shape; 2) pouring a liquid polyurethane material into the two half dies of the mold and allowing the polyurethane material to solidify to form a front part and a back part; 2) removing the front casing and back casing which are then repaired or touched-up as needed, and color painted; 3) making holes in the front casing and the back casing using needle-like tools and positioning an optical fiber through the holes; 4) bonding the two half casings together using an adhesive material and installing an electric core.

By using polyurethane material, this invention greatly simplifies the manufacturing process and makes manufacturing easier. The production efficiency is greatly increased compared with some prior methods. In addition, since the polyurethane material is elastic in nature, the semi-finished products and finished products do not easily break or crack from an impact or fall that may occur during transportation. The elastic nature of the material also makes it unnecessary to use special packing materials in order to meet safety and protection requirements, and the risk of the product being rejected is greatly reduced.

### BRIEF DESCRIPTION OF THE DRAWINGS

Additional features and advantages of the invention will be apparent from the detailed description which follows, taken in conjunction with the accompanying drawings, which together illustrate, by way of example, features of the invention, and wherein:

FIG. 1 is an illustration of the internal structure of an optical fiber product in accordance with an embodiment of the present invention; and

FIG. 2 is a front view of an embodiment of the present invention.

Reference will now be made to the exemplary embodiments illustrated, and specific language will be used herein to describe the same. It will nevertheless be understood that no limitation of the scope of the invention is thereby intended.

### DETAILED DESCRIPTION OF EXAMPLE EMBODIMENT(S)

This invention is a polyurethane optical fiber product, including a casing and optical fiber positioned on the casing. The casing is made of polyurethane material (i.e polyurethane), and consists of a front part (1) and a back part (2) which are bonded together.

The manufacturing technique of this polyurethane optical fiber product includes the following steps: 1) preparing a mold having a front half die and a back half die of a predetermined shape; 2) injecting a liquid polyurethane material into the two half dies of the mold and allowing the polyurethane material to solidify to form a front part and a back part; 2) removing the front casing and back casing which are then repaired or touched up as needed, and color painted; 3) making holes in the front casing and the back casing using, e.g., needle-like tools and positioning an optical fiber through the holes; 4) bonding the two half casings together using an adhesive material and installing an electric core.

The product can be made into different shapes according to the actual needs. In the embodiment depicted in the figures, the product is made into the shape of a Santa Claus. But the embodiment of this invention is not limited to this example.

To make this type of object, first, a pre-mold is made based on a sculpted model made of clay. The pre-mold will be inspected for quality, and then an aluminum alloy die mold will be made based on the pre-mold. The aluminum alloy die mold holds its shape and has a long useful life, which reduces costs.

The product is made by assembling two half casings. A polyurethane injection machine is used to inject the proper amount of polyurethane material, and one semi-finished product can be completed within 15 minutes. The production efficiency is very high (see Table 1). In addition, the semi-finished product will not break or crack from an impact or fall that may happen during transportation. In normal cases, one worker can make 32-35 sets of semi-finished product in one day using one set of dies. The highest productivity can be achieved with one worker by using three sets of dies.

TABLE 1
Production Efficiency of Different Materials
(For yield of one worker in one day)

| Process | Polymer Resin | Polyurethane Material |
|---|---|---|
| Demolding and forming | 4-5 | 32-35 sets |
| (one set of dies) | | |
| Hole opening-Optical fiber | 2 | 10-12 |
| positioning-Assembling | | |

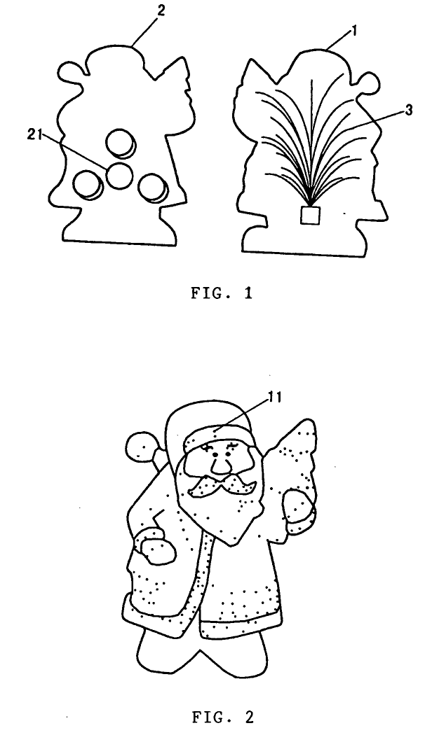

After molding, the dies are removed, and the two half cases, the front part (1) and the back part (2), can be formed (see FIG. 1). There is a core mounting hole on the back part (2). The half casings are then repaired or touched up as needed, any holes are filled, and the half casing is then color painted into the semi-finished product.

The optical fiber (3) is positioned on the front part (1). Since polyurethane is an elastic material, the operator can manually open the optical fiber positioning holes (11) and a core installation hole (21) using a sharp steel auger. This helps save working time, and one operator can make holes for 60-80 sets of product (30″ size) in one day. Because the product is a half case, it is simple to place the optical fiber in it, and it does not require the use of special tools. After positioning, the optical fibers are bound into bundles of proper length to reach the core installation hole (21) on the back part (see FIG. 1).

Adhesive is spread on the contacting surfaces of the front part (1) and the back part (2), and the two parts are adhered as one followed by some mending work if necessary.

The last step is the same as that for making conventional polymer resin optical fiber products. An electric core is mounted into the core installation hole on the back part (2) and connected with the optical fiber bundle. The electric core can be a circuit for powering the optical fibers, and/or for playing music, etc. When the power is connected, the optical fiber positioning hole (11) on the front part (1) which has the optical fiber mounted will start shining. This product is decorative and attractive.

As for packing, since polyurethane is a kind of foam expanded material that is very flexible and elastic, normal packing will be sufficient for passing a drop test, and product safety can be assured without the use of special packing materials.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

1. An optical fiber product, comprising:
a polyurethane casing; and
an optical fiber positioned on the casing.

2. An optical fiber product according to claim 1, wherein the casing comprises a front part and a back part, the front part and back part being adhered together to form the casing.

3. An optical fiber product in accordance with claim 1, further comprising an electric core, disposed within the casing.

4. An optical fiber product in accordance with claim 3, wherein the electric core is configured to power the optical fiber.

5. An optical fiber product in accordance with claim 4, wherein the electric core is configured to play music.

6. A process for manufacturing an optical fiber product, comprising the steps of:
1) preparing a mold having a front half die and a back half die of a predetermined shape;
2) pouring a liquid polyurethane material into the two half dies of the mold and allowing the polyurethane material to solidify to form a front part and a back part;
3) removing the front part and back part from the mold;
4) making a hole on the front part and the back part using a needle-like tool and positioning an optical fiber through the hole; and
5) bonding the two half parts together using an adhesive material and installing an electric core configured to power the optical fiber.

7. A process in accordance with claim 3, further comprising the step of painting the front part and back part after removal from the mold.

8. A process in accordance with claim 3, wherein the electric core is configured to play music.
